(19) United States
(12) Patent Application Publication
(10) Pub. No.: US 2016/0180372 A1
(43) Pub. Date: Jun. 23, 2016

(54) SYSTEMS AND METHODS FOR ONLINE ADVERTISEMENT REALIZATION PREDICTION

(71) Applicant: Yahoo! Inc., Sunnyvale, CA (US)

(72) Inventors: Quan LU, San Diego, CA (US); Kuang-chih Lee, Union City, CA (US); Donglin Niu, Sunnyvale, CA (US); Jian Xu, San Jose, CA (US)

(73) Assignee: Yahoo! Inc.

(21) Appl. No.: 14/577,223

(22) Filed: Dec. 19, 2014

(51) Int. Cl. G06Q 30/02; G06N 5/04; G06N 7/00

(52) U.S. Cl. CPC G06Q 30/0242; G06N 7/005; G06N 5/04

(57) ABSTRACT

A computer system implementing a method for ad realization prediction may be configured to receive a plurality of target realization factors associated with a target ad display opportunity; determine a reference realization probability score of the target ad display opportunity based on a global reference realization probability distribution associated with an ad display realization probability decision tree; using the reference realization probability score, determine an ad realization probability score of the target ad display opportunity according to a piecewise calibrated realization probability function; and return the ad realization probability score.

### TECHNICAL FIELD

The present disclosure generally relates to online advertising. Specifically, the present disclosure relates to systems and methods for predicting realization rate for online advertisements (ads).

### BACKGROUND

Online advertising is a successful business with multi-billion dollars revenue growth over the past years. The goal of online advertising is to serve ads to the right person in the right context. The efficiency of online advertising typically can be measured by different types of user responses, such as clicks, conversions, or application installations. In order to achieve the best ad efficiency, advertising systems try to predict the occurrence of user responses accurately given the combination of advertiser, publisher and user attributes. But although the realization rate (e.g., click through rate) of an ad for general public can be easily determined by statistically collecting the number of ads sent to the general public and the number of targeted responses received from the general public, when an advertisement is sent to an individual user, it is generally hard to accurately and quickly predict the response of the particular individual to the online ad, i.e., it is hard to accurately predict a probability that the particular user will take an realization action such as click the ad.

Various reasons contribute to the difficulties of predicting a user's response to an online ad. First, the user responses are typically rare events for non-search advertisement, and therefore variance will be large while estimating response rates. Since most of the advertising systems only serve the top ad selected based on the prediction result, outliers can be showed to users more easily, which decreases the performance if these advertising systems dramatically. Second, dimensionality of users' attribute space is quite large. Cardinality (i.e., the number of elements, or the size, of a set) of combinations of the attributes in the users' attribute space can easily run into millions. Finally, a large volume of ad transactions happen in a real-time environment, which requires the advertising system to estimate the price of each incoming ad request based on the response rate in a few milliseconds. In addition, top advertising systems typically serve millions of ad requests per second. Generally speaking, the short latency and high throughput requirements introduce strict constraints on the complexity of machine learning model to predict the response rate.

### SUMMARY

The present disclosure relates to systems and methods for online ad realization prediction. By collecting historical ad display realization data, the systems and methods may analyze realization factors about publishers, advertisers, and users associated with the data. Based on hierarchical relations of the realization factors, the system and methods may construct a realization probability decision tree. Splitting criteria is utilized in the construction of a decision tree. Splitting criteria for each leaf node in the decision tree ensures that each split in the decision tree results a stable realization probability distribution and that the realization probability distribution of the newly generated child nodes are substantially different from each other. Further, the systems and methods may calibrate the realization probability in each leaf node of the decision tree based on local historical ad display realization data within the leaf node.

According to an aspect of the present disclosure, a computer system may comprise a storage medium comprising a set of instructions for online ad realization prediction; and a processor in communication with the storage medium. When executing the set of instructions, the processor is directed to receive a plurality of target realization factors associated with a target ad display opportunity; determine a reference realization probability score of the target ad display opportunity based on a global reference realization probability distribution associated with an ad display realization probability decision tree; using the reference realization probability score, determine an ad realization probability score of the target ad display opportunity according to a piecewise calibrated realization probability function; and return the ad realization probability score.

The ad display realization probability decision tree comprises a plurality of leaf nodes, each leaf node comprising a plurality of historical ad display instances. The target ad display opportunity is associated with a target leaf node in the plurality of leaf nodes. The piecewise calibrated realization probability function comprises a plurality of pieces, where each piece is a regression function obtained from: the global reference realization probability distribution as an independent variable, and an actual realization probability distribution associated with a plurality of historical ad display instances in a leaf node as an induced variable.

According to another aspect of the present disclosure, a method for online ad realization prediction may comprise, by at least one computer, receiving a plurality of target realization factors associated with a target ad display opportunity; determining a reference realization probability score of the target ad display opportunity based on a global reference realization probability distribution associated with an ad display realization probability decision tree; using the reference realization probability score, determining an ad realization probability score of the target ad display opportunity according to a piecewise calibrated realization probability function; and returning the ad realization probability score.

The ad display realization probability decision tree comprises a plurality of leaf nodes, each leaf node comprising a plurality of historical ad display instances. The target ad display opportunity is associated with a target leaf node in the plurality of leaf nodes. The piecewise calibrated realization probability function comprises a plurality of pieces, each piece is a regression function obtained from: the global reference realization probability distribution as an independent variable, and an actual realization probability distribution associated with a plurality of historical ad display instances in a leaf node as an induced variable.

According to another aspect of the present disclosure, a non-transitory processor-readable storage medium may comprise a set of instructions for online realization prediction. When executed by a processor, the set of instructions may direct the processor to perform actions of: receiving a plurality of target realization factors associated with a target ad display opportunity; determining a reference realization probability score of the target ad display opportunity based on a global reference realization probability distribution associated with an ad display realization probability decision tree; using the reference realization probability score, determining an ad realization probability score of the target ad display opportunity according to a piecewise calibrated realization probability function; and returning the ad realization probability score.

The ad display realization probability decision tree comprises a plurality of leaf nodes, each leaf node comprising a plurality of historical ad display instances. The target ad display opportunity is associated with a target leaf node in the plurality of leaf nodes. The piecewise calibrated realization probability function comprises a plurality of pieces, each piece is a regression function obtained from: the global reference realization probability distribution as an independent variable, and an actual realization probability distribution associated with a plurality of historical ad display instances in a leaf node as an induced variable.

### BRIEF DESCRIPTION OF THE DRAWINGS

The described systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a schematic diagram of one embodiment illustrating a network environment that the systems and methods in the present disclosure may be implemented;

FIG. 2 is a schematic diagram illustrating an example embodiment of a server;

FIG. 3a illustrates a hierarchical structure of a realization rate database;

FIG. 3b is a flowchart illustrating a procedure to establish a realization rate database;

FIG. 4 illustrates a procedure of establishing a realization probability decision tree according to example embodiments of the present disclosure;

FIG. 5 illustrates two estimated realization probability distributions with substantial differences;

FIG. 6 is a flowchart illustrating a procedure of calibrating a realization probability decision tree;

FIG. 7 illustrates how an end node in a realization decision tree is calibrated using a linear regression method; and

FIG. 8 illustrates a procedure for conducting an online ad realization estimate using the online ad display realization probability decision tree.

### DETAILED DESCRIPTION

Subject matter will now be described more fully hereinafter with reference to the accompanying drawings, which form a part hereof, and which show, by way of illustration, specific example embodiments.

The present disclosure relates to systems and methods implementing a novel approach for predicating an online ad realization rate (RR) of an individual user by leveraging a trade-off between bias and variance. Although the present disclosure focuses on click-through rate (“CTR”) prediction, similar systems and methods may also be applied to predict any other user responses with respect to a piece of information a commercial entity sent to the user through internet.

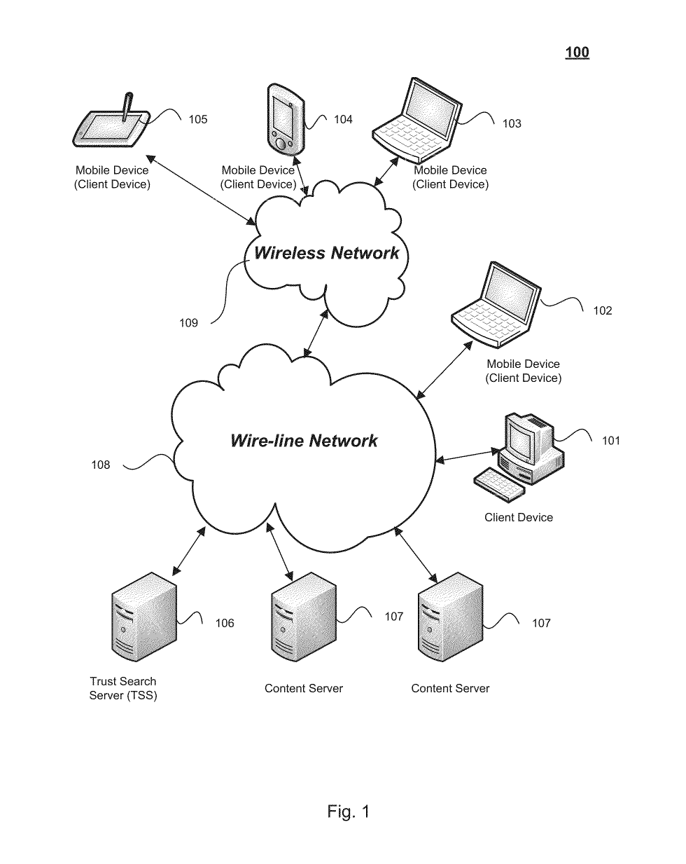

FIG. 1 is a schematic diagram of one embodiment illustrating a network environment that the systems and methods in the present application may be implemented. Other embodiments of the network environments that may vary, for example, in terms of arrangement or in terms of type of components, are also intended to be included within claimed subject matter. As shown, FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., content server 107 and search server 106) and client devices (e.g., client device 101-105 and mobile device 102-105) or other types of devices, including between wireless devices coupled via a wireless network, for example. A network 100 may also include mass storage, such as network attached storage (NAS), a storage area network (SAN), or other forms of computer or machine readable media, for example.

A network may also include any form of implements that connect individuals via communications network or via a variety of sub-networks to transmit/share information. For example, the network may include content distribution systems, such as peer-to-peer network, or social network. A peer-to-peer network may be a network employ computing power or bandwidth of network participants for coupling nodes via an ad hoc arrangement or configuration, wherein the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link. Overall, any type of network, traditional or modern, that may facilitate information transmitting or advertising is intended to be included in the concept of network in the present application.

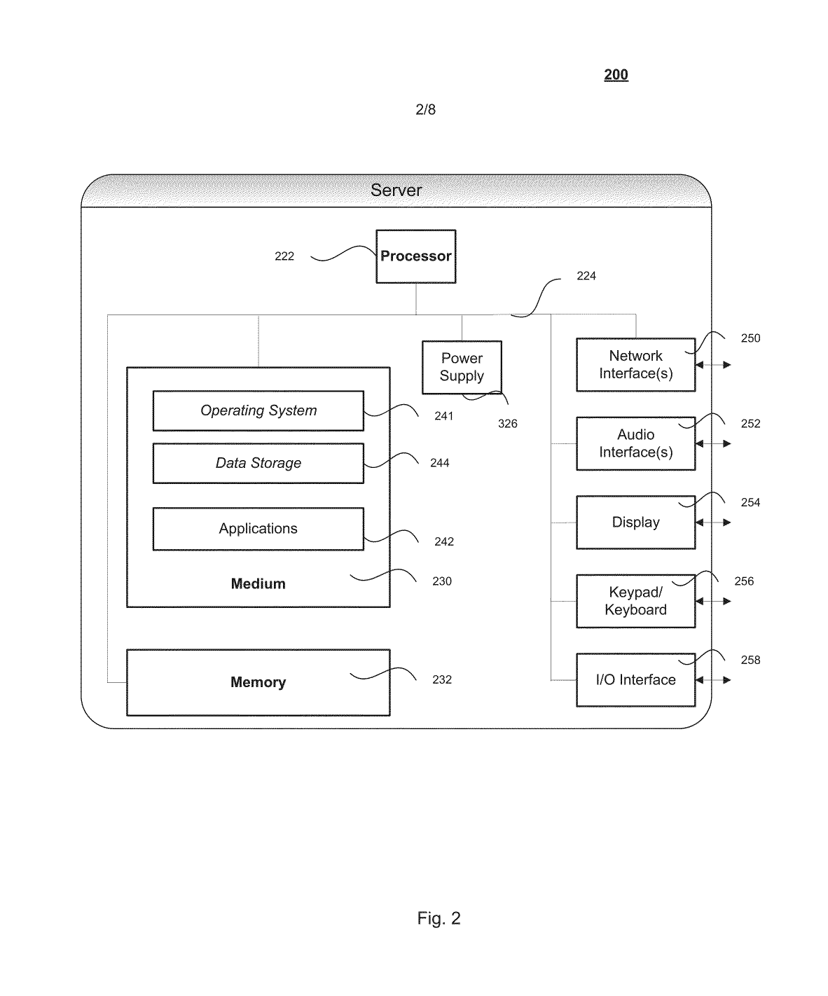

FIG. 2 is a schematic diagram illustrating an example embodiment of a server. A Server 200 may vary widely in configuration or capabilities, but it may include one or more central processing units (e.g., processor 222) and memory 232, one or more medium 230 (such as one or more non-transitory processor-readable mass storage devices) storing application programs 242 or data 244, one or more power supplies 226, one or more wired or wireless network interfaces 250, one or more input/output interfaces 258, and/or one or more operating systems 241, such as WINDOWS SERVER™, MAC OS X™, UNIX™, LINUX™, FREEBSD™, or the like. Thus a server 200 may include, as examples, dedicated rack-mounted servers, desktop computers, laptop computers, set top boxes, integrated devices combining various features, such as two or more features of the foregoing devices, or the like.

The server 200 may serve as a search server 106 or a content server 107. A content server 107 may include a device that includes a configuration to provide content via a network to another device. A content server may, for example, host a site, such as a social networking site, examples of which may include, but are not limited to, FLICKER™, TWITTER™, FACEBOOK™, LINKEDIN™, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor type or programmable consumer electronics, etc.

Merely for illustration, only one processor will be described in sever or servers that execute operations and/or method steps in the following example embodiments. However, it should be note that the server or servers in the present disclosure may also include multiple processors, thus operations and/or method steps that are performed by one processor as described in the present disclosure may also be jointly or separately performed by the multiple processors. For example, if in the present disclosure a processor of a server executes both step A and step B, it should be understood that step A and step B may also be performed by two different processors jointly or separately in the server (e.g., the first processor executes step A and the second processor executes step B, or the first and second processors jointly execute steps A and B).

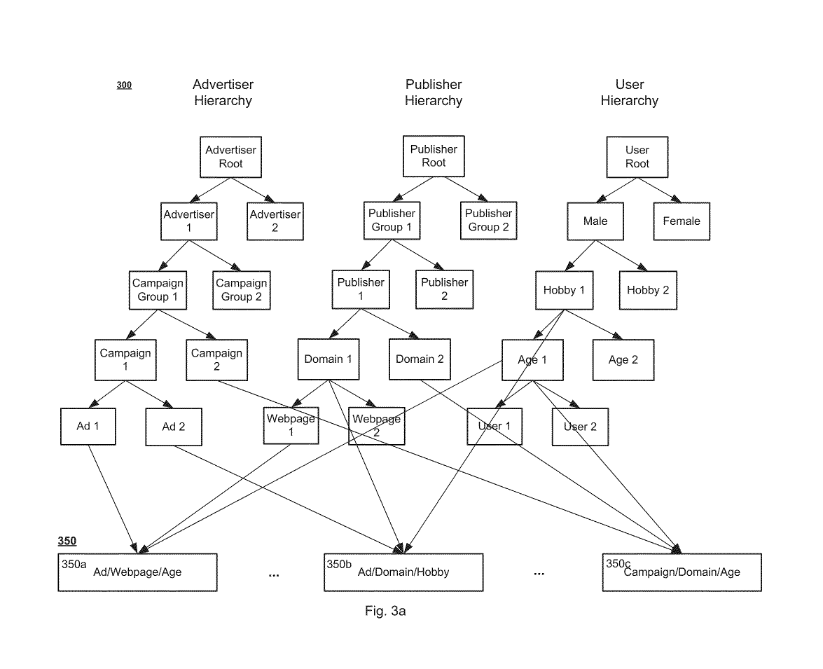

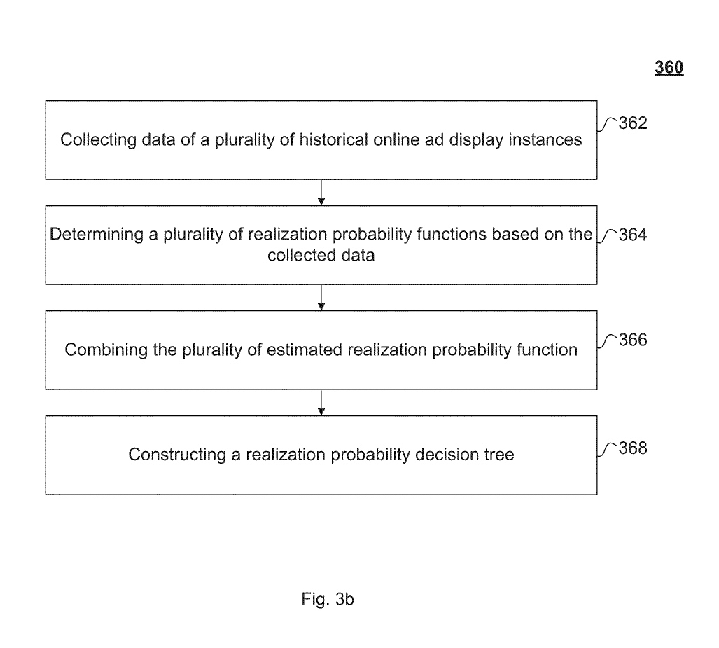

FIG. 3a illustrates a hierarchical structure of a realization rate database, such as a click through rate database or a conversion rate database. The realization rate database 300 may serve as a database to construct a realization rate estimation tree. The data therein may be collected by the server 200 from a plurality of client devices 101, 102, 103, 104, 105 through the wired and/or wireless network 108, 109. The realization rate database 300 may also be saved in a local storage medium 230 or a remote storage medium accessible by the server 200 through the network 108, 109.

FIG. 3b is a flowchart illustrating a procedure for establishing a realization rate database 300. The procedure may be stored in a storage medium 230 of the server 200 as a set of instructions, and may be executed by the processor 222 of the server 200. The procedure may include the follow operations:

Operation 362: the server 200 may collect data 350 from a plurality of historical online ad display instances. The server 200 analyzes the data 350 to identify factors (hereinafter “realization factors”) that have impacts on realization rate and/or realization probability. For example, in an ad display instance, factors related to a user (an ad viewer) that viewed an ad may include the user's demographic information such as a user's age, gender, race, geographic location, language, education, income, job, and hobbies. Factors related to the place where the ad is displayed may include information regarding where on a webpage the ad is displayed (e.g., webpage URL, webpage ID, and/or content category of the webpage, etc.), the domain information (e.g., URL, ID, and/or category of the website containing the webpage), and information and/or category of the publisher that places the ad on the webpage. Realization factors related to the ad may include information of the ad (e.g., ID, content/creative, and/or category of the ad), information of the ad campaign (e.g., ID and/or category of the ad campaign) that the ad belongs to, and/or the information of the advertiser (e.g., ID and/or category of the advertiser) that runs the ad campaign.

For example, for an ad and/or similar types of ads, the data 350 may include historical ad display data for the ad and/or similar ads displayed repeatedly in the same webpage, similar webpages, same website (domain), and/or similar websites, and viewed by same user, similar users, and/or users with various demographical features. In an ideal situation, each piece of data in the database may include all the information about the realization factors. But in reality, many pieces of data in the database may only associate with some of the realization factors.

Note that the realization factors in the collected historical data 350 of online ad display instance may have natural hierarchy relationships. For example, in FIG. 3a, a user's hobby may include sports in a Sport category and arts in an Art category and the Sport category may be further divided into different sub-categories such as golf and fishing. Similarly, in the publisher side, a publisher may run a number of domains (e.g., websites), and each domain may include a plurality of webpages. In the advertiser side, ad Campaign Group1 may include ad Campaign1, which may further include a plurality of ads such as Ad1 and Ad2. Accordingly, the server 200 may analyze and/or categorize the historical data 350 of online ad display instances based on the hierarchy relationships of the factors. For example, data 350a may be a dataset that includes a realization history for Ad1 when Ad1 was displayed on Webpage1 for users who play golf; data 350b may be a dataset that includes a realization history of Ad2 when Ad2 was displayed in Domain 1 for users whose some hobby information under the Hobby category is known. Data 350c may be a dataset that includes a realization history of ads in Campaign2 when these ads were displayed on Domain2 for users play a sport under the Sport category.

Based on how fine of a dataset of historical ad display instances can be categorized, the dataset may be described to have a corresponding granularity. A category that can be broken down into smaller sub-categories has a coarser granularity (or larger grained or coarser grained) than its sub-categories (i.e., finer granularity, smaller grained, or finer grained). For example, a webpage may be finer grained than a domain. Accordingly, a dataset, such as dataset 350a, which is associated with finer granularity level are finer grained than a dataset, such as dataset 350c, which is associated with coarser granularity level.

Operation 364: after collecting the data 350 from the historical online ad display instances, the sever 200 may analyze the data 350 for estimated realization rate, i.e., to determine a realization probability as a function of the realization factors with different granularities. Depending on how completely the data 350 are associated with the realization factors, the realization probability may be a function of only one realization factor or may be a function of multiple realization factors. For example, the server 200 may choose factor pair Domain and Ad as a dimension D₁={Domain, Ad} to determine values of an estimated realization probability p(realize|Domain, Ad). Mathematically, this function incorporates all the domain-ad combinations available in the in the collected historical data 350 and provides an estimated realization probability to every domain-ad combination. For example, for a particular ad, e.g., Ad1, in the realization rate database 300, the estimated realization probability function may represent an estimated probability of realizing (e.g., clicking through) Ad1 on any domain (e.g., website) in the factor set D₁={Domain, Ad1}. For a particular domain, e.g., Domain1 in the realization rate database 300, the estimated realization probability function may represent the probability of realization for any ad in the factor set D₁={Domain1, Ad} when the ad is displayed in this particular domain, Domain1. Similarly, the server 200 may also analyze the estimated realization function with coarser granularity. For example, the server 200 may choose Domain and Campaign as the factor set to determine values of the estimated realization probability function p(click|Domain, Campaign). Some factors are combinable to form a factor set, such as D₁={Domain, Ad} for the purpose of the estimate realization probability calculation; some other combination of factors, such as a domain and a webpage therein, may not be needed for the purpose of calculating an estimate ad realization probability. A factor set, when combined together, may also become a factor since the set is now considered as a whole.

When other factors are the same, the server 200 may place the estimated realization probability function of a finer grained realization factor a higher priority over the realization function of a coarser grained realization factor. For example, because data related to factor Ad are finer grained than data related to factor Campaign, the server 200 may use p(realization|Domain, Ad) first for realization probability analysis and use p(realization|Domain, Campaign) if there is not enough data for p(realization|Domain, Ad).

These realization factors, including individual factors and possible combinations thereof, collectively may form an n-dimensional set

D={D₁,D₂, . . . ,Dₙ},

where Dᵢ, i=1 . . . n represents each factor and possible factor combination in the set D. Among the n-dimensional set, the server 200 may take m dimensions to calculate the estimated realization probability. Accordingly, for each dimension (i.e., factor and/or factor set) Dᵢ⊂D in the m-dimensional subset, the realization probability function may be

pᵢ=p(realization|Dᵢ⊂D),

where i=1, 2, . . . , m, and the corresponding estimated realization probability function set is

P={p₁,p₂, . . . ,pₘ}.

Some dimensions, such as a factor including Gender (male or female) or Age (e.g., 1 to 100) of the users, may have low cardinality (i.e., the number of elements, or the size, of a set) because there are only 2 genders in the world and most of the Internet user in the historical data 350 are younger than 100 years old. Some dimensions, such as a factor set including Ad, Webpage, and/or Domain, may have high cardinality because there can be endless number of ads, webpages, and domains available on Internet. A low cardinality set may likely have a dimension in a scale equal to or less than 10² (i.e., around or lower than 1000). A low cardinality set may be easily bucketized and may only have low number of (e.g., dozens of) unique values. A high cardinality set may be more than ten times bigger than the low cardinality set and may have up to tens of thousands of unique values. Since D={D₁, D₂, . . . , Dₘ} is a set with very high cardinality, the estimated realization probability function set, P={p₁, p₂, . . . , pₘ} is also a high cardinality set.

The total estimation error for the realization probability function set P may include two components of errors: error due to bias and error due to variance. Because of the high cardinality, the estimated realization probability function set P may have a small error of bias and a large error of variance.

To reduce the error of variance, the server 200 may combine a plurality of the estimated realization probability functions pᵢ. For example, the server 200 may combine all probability functions in the estimated realization probability function set P through bagging algorithm. Bagging is a machine learning ensemble meta-algorithm designed to improve the stability and accuracy of machine learning algorithms used in statistical classification and regression. The algorithm also reduces variance and helps to avoid overfitting.

To this end, in Operation 366, the server 200 may combine the m estimated realization probability functions via a bagging function

h=p(realization|D)=f(p₁, . . . ,pₘ),

where h is the combined realization probability function; and f is the bagging function. This disclosure intends to cover all applicable bagging functions perceivable by one of ordinary skill in the art at the time of this application. For example, the bagging function may be an average of all the estimated realization probability function,

f(p₁, . . . ,pₘ)=Σpᵢ/m,

where i=1, 2, . . . , m; or the bagging function may be a scaled average function,

f(p₁, . . . ,pₘ)=(Σaᵢ·pᵢ)/m,

where the weight aᵢ is a positive value between 0 and 1. There may be various ways to define the value of the weight aᵢ. For example, the value of aᵢ may reflect the granularity level of the i^{th} estimated realization probability function. The finer the granularity of the i^{th} estimated realization probability function is, the greater the corresponding weight aᵢ.

Therefore, the combined realization probability function may represent a global average realization probability distribution over an entire data set of the historical online ad display instances in the ad display realization probability decision tree. By combining the m estimated realization probability function, the error of variance due to the large cardinality may be reduced. Thus the combined realization probability function may serve as a reference function to adjust the errors in the estimated probability.

After obtaining the combined m estimated realization probability function h, in Operation 368, the server 200 may construct a realization probability decision tree using a decision tree based algorithm, such as the Algorithm 1 shown below.

Algorithm1: TreeConstruction

Input: I, D₁, ..., Dₗ, N(N ≦ l), τ_{score}
Output: tree T
1: initialize F = {up to N − gram features from D₁, ..., Dₗ}
2: initialize queues Q = 0; tree T = null
3: push I into Q
4: set I root of T
5: while Q ≠ 0 do
6: S = pop Q
7: best_score = 0
8: best_feature = null
9: for f ∈ F do
10: S_{f} = {I|I ∈ S [symbol] I satisfies f}
11: S_{f̅} = S − S_{f}
12: score(f) = EvaluateSplit(S_{f}, S_{f̅})
13: if sore(f) > best_score then
14: best_score = score(f)
15: best_feature = f
16: end if
17: end for
18: if best_score > τ_{score} then
19: set S parent of S_{best_feature} and S_{b̅e̅s̅t̅_̅f̅e̅a̅t̅u̅r̅e̅}
20: push S_{best_feature} and S_{b̅e̅s̅t̅_̅f̅e̅a̅t̅u̅r̅e̅} into Q
21: end if
22: end while
23: return T

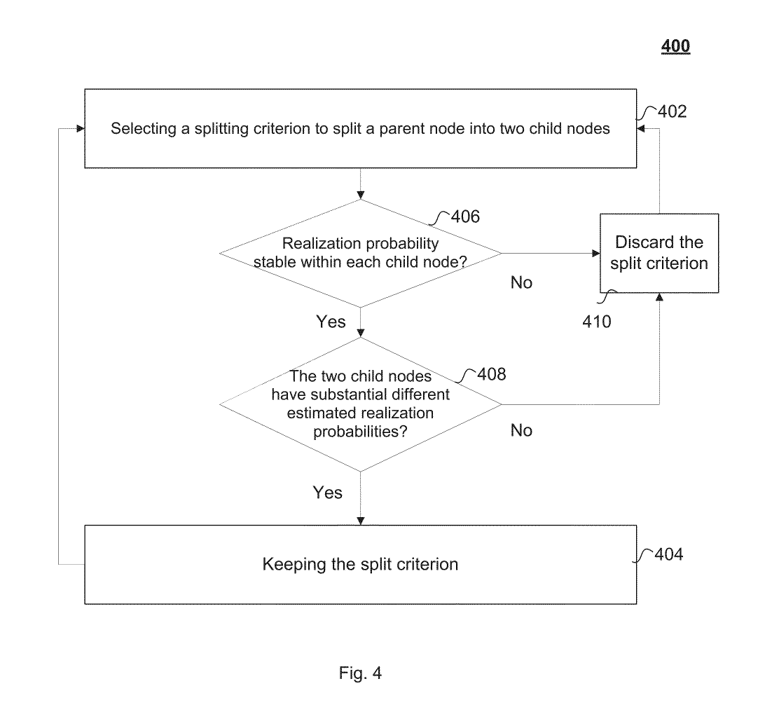

FIG. 4 illustrates a procedure of constructing the realization probability tree with respect to the factors D={D₁, D₂, . . . , Dₘ} according to example embodiments of the present disclosure. The procedure may be stored in a storage medium 230 of the server 200 as a set of instructions, and may be executed by the processor 222 of the server 200.

The server 200 may implement the decision tree based algorithm to construct the realization probability decision tree. In the algorithm shown above, I is all the training instances in the root node of the realization probability decision tree and the algorithm takes I factors (or combination of factors) demoted by {D₁, . . . , Dₗ}. To be practical for training {D₁, . . . , Dₗ} may have low-cardinality. Alternatively, {D₁, . . . , Dₗ} may be of high-cardinality. The corresponding set of ad display data (historical online ad display instances) may be treated as a root node of the ad display realization probability decision tree.

To construct the realization probability decision tree, in Operation 402, the server 200 may select a splitting criterion to split a parent node into two child nodes: a first node including the online ad display instances that satisfies the splitting criterion and a second node including the remaining online ad display instances that do not satisfy the splitting criterion. Contrary to the classical tree algorithm, wherein the decision of splitting one parent tree node is only based on an individual feature variable as the splitting criterion, the present disclosure may consider one or more or all of the possible combinations of multiple realization factors as splitting criteria. For example, in an implementation, the server 200 may take up to three features (3-grams) and the combination thereof for splitting a parent tree node. For example, the server 200 may select a factor (Age=[30-40],Gender=Female) as a splitting criterion. The criterion may split (i.e., distinguish) instances of ad display in the parent node into 2 child nodes: ad display instances viewed by female users who were between 30-40 years old as one child node; and ad display instances viewed by other users in the parent node to which the splitting criterion is applied as another child node. This method has two advantages: first, it may overcome the potential myoptics of the classical tree algorithm. Second, although a binary tree is generated by splitting, this binary tree is similar to the results of the classical tree algorithm using full tree generation and a complex prune algorithm. Thus there is no need to consider complex prune algorithm anymore.

After splitting the parent node into two child nodes, in Operation 404, the server 200 may keep the splitting criterion and apply another splitting criterion to further split the child nodes or some of the child nodes to grandchild nodes. As a parent node is split, the realization probability distribution associated with the ad display instance in the parent node is split as well. The server 200 may keep splitting the nodes in the realization probability decision tree until a predetermined percentage of the child nodes and/or grandchild nodes (e.g., all child and/or grandchild nodes) therein comprise satisfactory realization probability distributions and/or results. The nodes in the lowest layer of the realization probability decision tree are called leaf nodes.

The splitting criteria may be selected based on a number of construction requirements. A finally selected splitting criterion may provide a best split result to the parent node under the construction requirements. If a splitting criterion does not meet with one or more of the construction requirements, the server 200 may reject the splitting criterion. For example, the construction requirements may include, but not limited to, the following two requirements:

First, the corresponding realization probability estimation of each of the two child nodes under the splitting criterion is stable over a period of time within each child node of the realization probability decision tree. In Operation 406, the server 200 may determine a realization probability distribution for the historical online ad display instances in each of the first and second child nodes, based on the historical online ad display instances therein. The server 200 may keep the two child nodes if both of the realization probability distributions are stable over a predetermined period of time, such as a week. The server 200 may discard the splitting criterion if the realization probability distribution of any of the child nodes is unstable, Operation 410. This requirement emphasizes low variance within a leaf node. Under this requirement, leaf nodes that are generated under a splitting criterion may be able to provide stable realization probability prediction over time. A variation and/or error of the probability prediction in a leaf node over a predetermined period of time may be equal to or smaller than a predetermined variation value and/or error value. For example, the server 200 requires that under the splitting criterion (Age=[30-40], Gender=Female), variation of ad realization probability for female users between ages 30-40 should not vary over a predetermined value over a predetermined period of time (e.g., 1 week). If the server 200 finds that female users between age 30-40 behaves inconsistently with respect to realizing online advertisements, the server 200 may discard the splitting criterion (Age=[30-40], Gender=Female).

Second, in Operation 408, the server 200 may determine that the splitting criterion splits a parent node into two child nodes with substantial different the realization probability distributions (e.g., estimated realization probabilities), i.e., the first and second realization probability distributions are substantially apart. If the difference is not substantial, the server 200 may discard the splitting criterion, Operation 410.

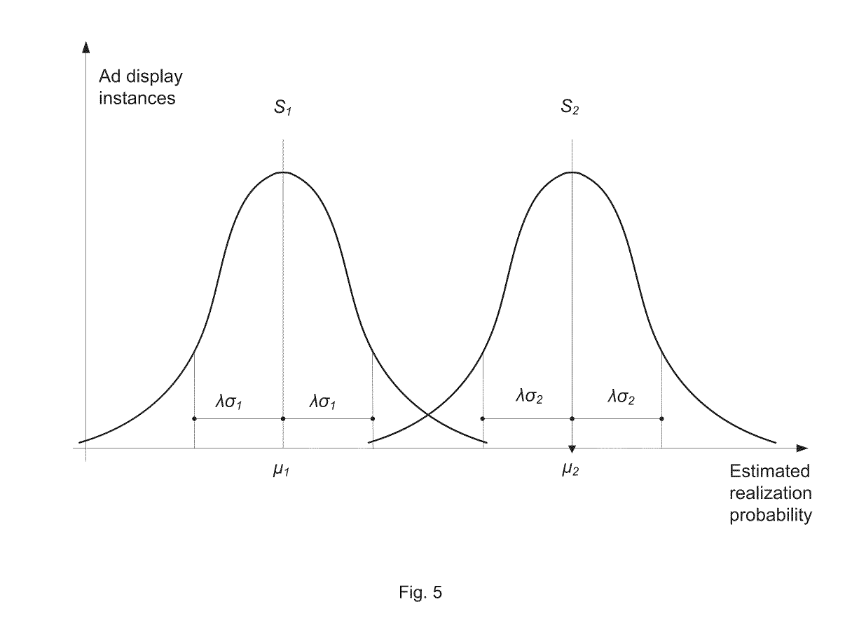

FIG. 5 illustrates two estimated realization probability distributions with substantial differences. If a parent node is split into two subsets (i.e., two child nodes) of ad display instances S₁ and S₂, the server 200 may apply a function EvaluateSplit (S₁; S₂) to obtain an evaluation score of such a split to determine whether the two child nodes have substantial different realization probability distributions. To this end, the server 200 may calculate an average realization probability μ₁ and an over-time variance σ₁ for S₁; the server 200 may also calculate an average realization probability μ₂ and an over-time variances σ₂ for S₂. Taking the child node S₁ as an example, the server 200 first may order all the instances in the node S₁ by time and bucketize them into K time slots. The server 200 may determine the estimated realization probability for each time slot, and take a variance of the K average estimate realization probability as σ₁.

Next, the server 200 may determine the evaluation score to show how much the two child nodes of ad display instances S₁ and S₂ overlap with each other. If the evaluation score is equal to or higher than (or lower than) a predetermined value, the server 200 may determine that the two child nodes have substantial different estimated realization probabilities. For example, in FIG. 5, S₂ is the child node having a larger average realization probability μ₂>μ₁. The server 200 may take λδ₁ and λσ₂ as the predetermined variances threshold values for the two subsets of ad display instances S₁ and S₂ respectively, where λ is a positive number. The two predetermined variance threshold values respectively define a realization probability distribution zone [μ₁−λσ₁, μ₁+λσ₁] of S₁ and a realization probability distribution zone [μ₂−λσ₂, μ₂+λσ₂] of S₂. Using the two predetermined variance threshold values, the server 200 may determine the overlap between the two realization probability distribution zones as the evaluation score. For example, the server may determine a value of log [(μ₂−λσ₂)/(μ₁+λσ₁)], which reflects a comparison between the lower boundary (μ₂−λσ₂) of the realization probability distribution zone of S₂ and the higher boundary (μ₁+λσ₁) of the realization probability distribution zone of S₁. If log [(λ₂−λσ₂)/(μ₁+λσ₁)] is greater than a predetermined value, the server 200 may determine that the two subsets of ad display instances S₁ and S₂ are substantially different, i.e., the first and second realization probability distribution is far away enough. For example, if log [(μ₂−λσ₂)/(μ₁+λσ₁)]>0, which means (μ₂−λσ₂)>(μ₁+λσ₁), the server 200 may determine that the two subsets of ad display instances S₁ and S₂ are substantially different. Conversely, if log [(μ₂−λσ₂)/(μ₁+λσ₁)] is smaller than or equal to the predetermined value, the server 200 may determine that the two subsets of ad display instances S₁ and S₂ are substantially overlapped, thus are not substantially different, i.e. the first and second realization probability distributions overlap over a predetermined degree. For example, if log [(μ₂−λσ₂)/(μ₁+λσ₁)]≦0, which means (μ₂−λσ₂)≦(μ₁+λσ₁), the server 200 may determine that the two subsets of ad display instances S₁ and S₂ are not substantially different.

As can be seen from the above description, the evaluation score is derived as a conservative estimation of the child node S₂ with higher realization probability mean value divided by the aggressive estimation of the child node S₁ with lower realization probability mean value. λ is a parameter to control how important variance plays its role. For example, if λ=0, the score is simplified as only looking at the average realization probability difference. The evaluation score may consider both the between-node difference of average realization probability and the over-time variance, as the split results in segmentations (neighborhoods) are expected to be informative and stable in future calibrations. More specifically, as described in EvaluateSplit (S₁; S₂) shown below, if either S₁ or S₂, has less than a predetermined number of clicks, the score is 0.

Algorithm2: EvaluateSplit (S₁; S₂)

Input: S₁, S₂, τ_{realization}, λ
Output: score
1: if realizationₙum(S₁) < τ_{realization}or realizationₙum(S₁) < τ_{realization} then
2: return 0
3: end if
4: μ₁ = r̅e̅a̅l̅i̅z̅a̅t̅i̅o̅n̅ p̅r̅o̅b̅a̅b̅i̅l̅i̅t̅y̅(̅S̅₁̅)̅
5: μ₂ = r̅e̅a̅l̅i̅z̅a̅t̅i̅o̅n̅ p̅r̅o̅b̅a̅b̅i̅l̅i̅t̅y̅(̅S̅₂̅)̅
6: σ₁ =TVariance(S₁)
7: σ₂ = TVariance(S₂)
8: if μ₁ = μ₂ then
9: return 0
10: else if μ₁ > μ₂
$11 \text{:} return log \frac{{μ}_{1} - {λσ}_{1}}{{μ}_{2} + {λσ}_{2}}$
12: else
$13 \text{:} return log \frac{{μ}_{2} - {λσ}_{2}}{{μ}_{1} + {λσ}_{1}}$
14: end if

Through this method, the server 200 may construct the realization probability decision tree from the database 300 of historical ad display instances. The realization probability decision tree may categorize the ad display instances in the database 300 based on demographical features of different users, features of different publishers, and/or features of advertisers. Thus, piecewise, the server 200 may construct the whole spectrum of realization probability into a plurality of estimated realization probability pieces. Each estimated realization probability piece is a leaf node and contains a small neighborhood and/or range of estimated realization probability values with low variance.

Also, because the online ad display instances may have natural hierarchy relationships as shown in FIG. 3a, the splitting criterion naturally bears the hierarchy relationships with each other. For example, the splitting criterion (Age=[30-40], Gender=Female) naturally satisfies the hierarchy relationship of the user hierarchy as shown in FIG. 3a. Thus, the realization probability decision tree may be constructed to naturally reflect realization probability distribution based on the advertiser hierarchy, publisher hierarchy, the user hierarchy, or any combination thereof. Thus each leaf node may be viewed as a collection of instance reflecting and/or associated with realization probability distributions of advertisers, publishers, and/or users. For illustration purpose only, the below description only discuss the scenario where the realization probability decision tree is used to analyze users' realization probability. Accordingly, each leaf node of the realization probability decision tree may also be treated as a collection of instances of ad viewing by users who share similar demographical features.

Further, depending on the need, the realization probability decision tree may be constructed as a shallow tree to facilitate indexing and searching speed.

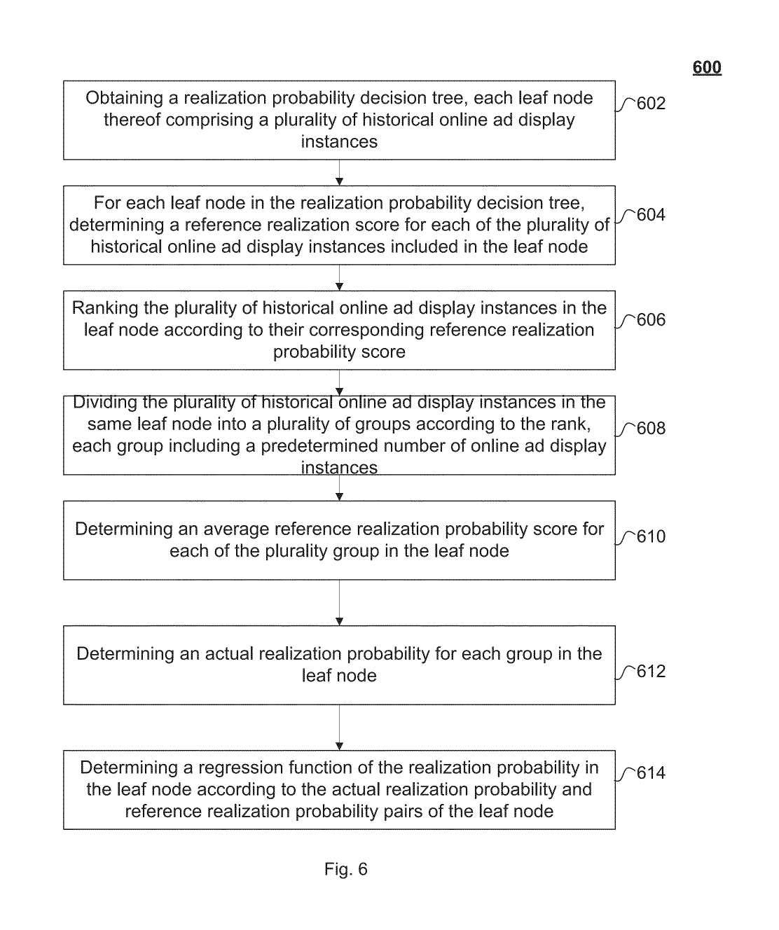

After constructing the realization probability decision tree, the server 200 may proceed to calibrate the realization decision tree to further reduce prediction error. FIG. 6 is a flowchart illustrating a procedure to calibrating the realization probability decision tree using a linear regression method. The procedure may be stored in a storage medium 230 of the server 200 as a set of instructions, and may be executed by the processor 222 of the server 200.

Operation 602: the server 200 obtains the realization probability decision tree. Each node in the realization probability decision tree may comprise a plurality of historical online ad display instances that are associated with similar users, similar advertisers, and/or similar publishers categorized by at least one unique splitting criterion as set forth above.

Operation 604: for each leaf node in the realization probability decision tree, the server 200 determines a reference realization probability distribution for the online ad display instances included in the leaf node.

The reference probability may be the combination of the probabilities from all the nodes in the tree. In other words, the probability on each single node is first calculated, and then these probabilities are combined together through a function for each node. The function may be of the same formula for the nodes, or different node may have different implementation of the function. As an example of the disclosure, the reference realization probability distribution may be the combined estimated realization probability function h. To obtain the reference realization probability distribution, the server 200 may apply the combined estimated realization probability function h to the online ad display instances in each leaf node in the tree. As a result, the server 200 may obtain a reference realization probability score for each of the plurality of historical online ad display instances in the leaf node. For example, the i^{th} leaf node of the estimate realization decision tree may include 2000 online ad display instances involving users that are 30-40 years old female viewing sport news webpages such as sports.yahoo.com of YAHOO!™. The server 200 has found that this group of users has a similar click through rate on certain types of ads displayed when they visited those sport news webpages. The server 200 may input the demographic information of each user (as well as realization factors under the advertiser and publisher hierarchies) into the combined estimated realization probability function h to determine the reference realization probability score for each of the 2000 ad display instances.

Operation 606: the serer 200 then may rank the plurality of online ad display instances in the leaf node in an order according to their corresponding reference realization probability score. The order of the rank may be monotone increasing in the reference realization probability scores, i.e., the order may start from an online ad display instance with the lowest score and end with an online ad display instance with the highest score. Alternatively, the ranked order may be monotone decreasing in the reference realization probability scores, i.e., the order may start from the highest score and end with the lowest score.

Operation 608: the server 200 then divides the plurality of online ad display instances in the same leaf node into a plurality of groups according to the rank. Each group includes a predetermined number of online ad display instances. For example, the server 200 may divide the 2000 online ad display instances into 20 groups according to the ranked order, where each of the plurality of groups may include 100 historical online ad display instances. The first group may include the first 100 historical online ad display instances in the ranked order; the second group may include the second 100 historical online ad display instances in the order, so on and so forth.

Operation 610, the server 200 may determine an average reference realization probability score for each of the plurality of groups in the leaf node. For example, the server 200 may take the combined estimated realization probability scores of the first group (i.e., the first 100 online ad display instances in the i^{th} leaf node) and determines an average score for the 100 reference probability scores equals 4.8%. This score may be served as a reference score of the group of online ad display instances.

Operation 612: the server 200 then determines an actual realization probability for each group in the leaf node. To this end, the server 200 may determine the number of online ad display instances in the group that were actually realized (e.g., being clicked), and divided this number with the predetermined number of the group. For example, for the 100 online ad display instances in the j^{th} group, the server 200 may determine that only 5 online ad were actually clicked. Accordingly, the server 200 may determine that 5% of female users between 30-40 years old will click through certain type of ads appear on a sport webpage such as sports.yahoo.com.

Alternatively, the server 200 may also use a weighted average based on the distance between online ad display instances within the same leaf node as the actual realization rate. Under this model, let I be an instance in this node and the combined realization estimation is h(I). Let kNN(I) be the k nearest neighbor of I in terms of h. The server 200 may determine the actual realization probability under the formula

$$\hat{p} ( I ) = \frac{{\sum }_{j} ω ( {I}_{j} ) \times realization ( {I}_{j} )}{{\sum }_{j} ω ( {I}_{j} )}$$

where IⱼεkNN(I), realization(Iⱼ) is a {0, 1} variable indicating whether Iⱼ has been realized, and ω(Iⱼ) is the weight of the Iⱼ. ω(Iⱼ) is defined based on the h distance between Iⱼ and I. Let

σ=½×[amx(h(Iₓ)|IₓεkNN(I))−min(h(I_{y})|I_{y}εkNN(I))],

the weight ω(Iⱼ) is under the formula

ω(Iⱼ)=Normal[h(Iⱼ)−h(I),σ].

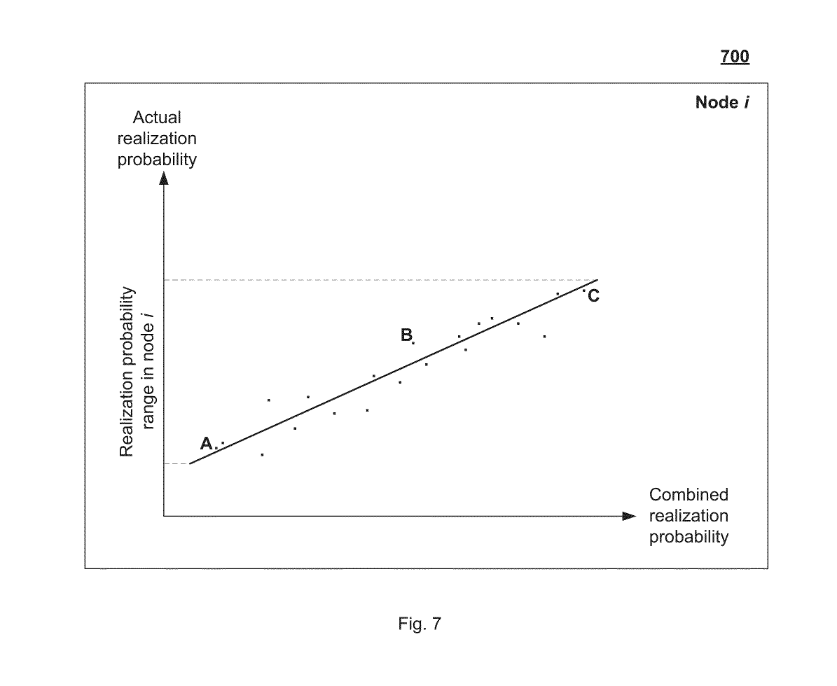

Thus, for each group of the plurality of groups, the server 200 may obtain a data set that includes the actual realization probability for the group and the reference probability for the group in the leaf node. For example, there are 20 groups of historical online ad display instances in the i^{th} leaf node. Accordingly, the server 200 may obtain a set of 20 data pairs, each pair includes an actual realization probability value and a reference probability value obtained from the globally combined estimated probability value. FIG. 7 illustrates a distribution of the 20 data pairs, where the horizontal axis is the reference probability of the 20 groups and the vertical axis is the actual realization probability of the 20 groups.

Operation 614, the server 200 may determine a regression function of the realization probability in the leaf node according to the actual realization probability and reference realization probability pair of the leaf node. For example, the server 200 may train a piecewise linear regression model using the set of data. The linear regression model may use a formula of

p=aⱼ×h+bⱼ

where h is the combined estimated realization probability function for online ad display instances in the leaf node, and j=1, . . . , t are t groups of the online ad display instances in the piecewise regression model. p may be monotonic and continuous at the break points cᵢ₊₁ between two adjacent leaf nodes, i.e.,

aⱼ×cⱼ₊₁bⱼ=aⱼ₊₁×cⱼ₊₁bⱼ₊₁.

For example, in FIG. 7, the straight line represents a linear regression function determined through the linear regression model.

Algorithm3: PiecewiseRegression

| Input: tree T, nearest - neighbor parameter k | |
|---|---|
| Output: piecewise linear regression model for each leaf node | |
| 1: | for each leaf node Node do |
| 2: | for each instance I ε Node do |
| 3: | kNN(I) = k nearest neighbor of I within Node |
| 4: | $\hat{p} ( I ) = \frac{{\sum }_{j} ω ( {I}_{j} ) \times realization ( {I}_{j} )}{{\sum }_{j} ω ( {I}_{j} )} , where {I}_{j} ∈ kNN ( I )$ |
| 5: | end for |
| 6: | Derive a piecewise linear regression PLR_{Node} |
| 7: | end for |
| 8: | return all the PLRs |

Accordingly, the server 200 may obtain a monotonic, continuous, but piecewise calibrated realization probability decision function. The input of the function may be the reference realization probability, i.e., the globally combined realization probability function h, and the output of the function is the piecewise calibrated actual realization probability. When an online ad display instance appears, i.e., a user visits a webpage and the publisher sends an ad to the user, the server 200 may obtain the advertiser information (e.g., realization factors related to the ad etc.), the publisher information (e.g., realization factors related to the webpage etc.), and the user information (realization factors related to the user etc.). The server 200 then may apply these factors to the combined realization probability function h to determine a reference realization probability for the online ad display instance. The server 200 then may determine the actual realization probability of the online ad display instance through the calibrated realization probability decision function. Because the realization probability is calibrated by historical online ad display instances in a small neighborhood around the current online ad display instance, the accuracy of the actual realization probability determined through the function may be greatly improved.

To conclude, in the present disclosure, the server 200 may first derive a hierarchical model (e.g., the realization probability decision tree) from high-cardinality dimensions and combine estimations from different cells (e.g., the leaf node of the tree) via bagging. Then the bagging score is calibrated against piecewise linear regression model trained within the neighborhood defined by a shallow realization probability tree. The tree is learned from low-cardinality dimensions. At serving time, when the server 200 need to estimate the realization probability for a new impression, the server 200 may first compute the bagging score from hierarchical model and convert it to the final estimation by the piecewise linear model learned within the node that the impression falls in.

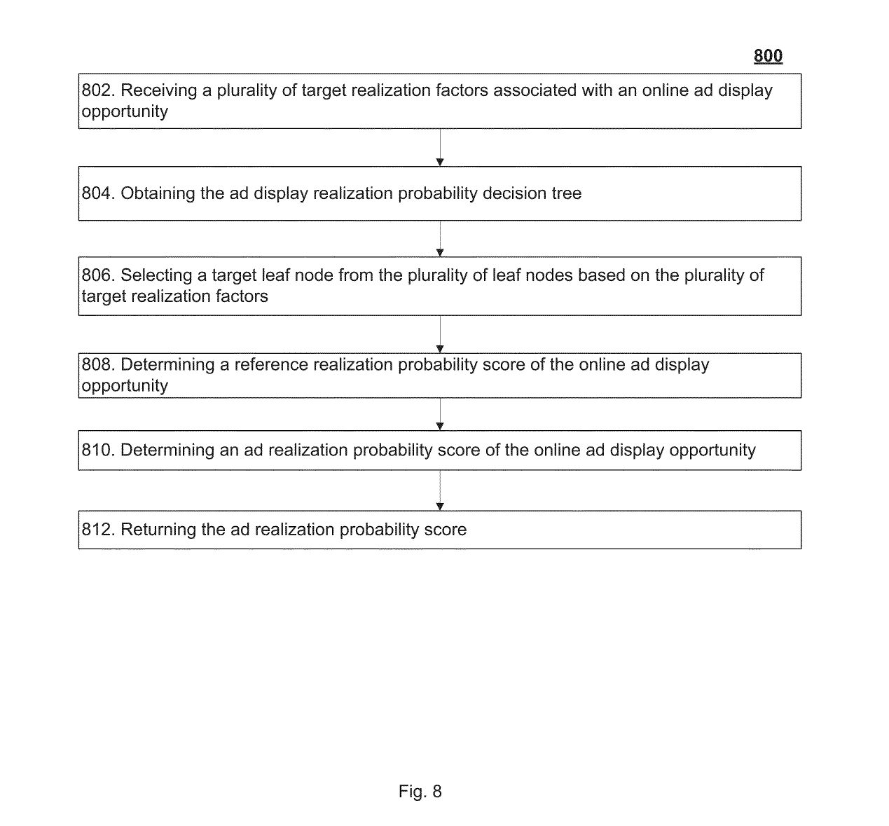

FIG. 8 illustrates a procedure for conducting an online ad realization estimate using the online ad display realization probability decision tree set forth above. The procedure may be stored in a storage medium 230 of the server 200 as a set of instructions, and may be executed by the processor 222 of the server 200.

In Operation 802, the server 200 may receive a plurality of target realization factors associated with an online ad display opportunity. When a user opens a website, an online advertising opportunity is created. A publisher may notify the opportunity to a plurality of advertisers, who may bid the opportunity to send an ad on the webpage that the user is viewing. The server 200 may receive the corresponding realization factors of this opportunity and the ad to be bid and/or displayed in order to determine a realization probability if the particular ad is displayed on the particular webpage and being viewed by the user at that particular moment.

In Operation 804, the server 200 may obtain the ad display realization probability decision tree. As introduced above, the ad display realization probability decision tree may include a plurality of leaf nodes. Each leaf node may include the plurality of historical ad display instances and a localized realization probability function that bears the formula of p=aⱼ×h+bⱼ, where j represent the identification of a leaf node. Each historical ad display instance may be associated with at least one realization factor.

In Operation 806, based on the target realization factors of the ad display opportunity, the server 200 may find and select a right leaf node (i.e., a target leaf node) from the plurality of leaf nodes in the ad display realization tree.

In Operation 808, the server 200 may determine a reference realization probability score of the online ad display opportunity. The score may be determined by applying the plurality of target realization factors to the combined realization probability function h (i.e., a global reference realization probability distribution) which is associated with the ad display realization probability decision tree.

In Operation 810, the server 200 may apply the reference realization probability score of the online ad display opportunity to the local regression function in the target leaf node. As stated above, the regression function may have a formula as p=aⱼ×h+bⱼ, where j represent the identification of the target leaf node, h is the global reference realization probability distribution (i.e., the corresponding reference realization probability score of the online ad display opportunity), serving as an independent variable, p is the actual realization probability distribution of the ad display opportunity, serving as an induced variable. As a result, the server 200 may find and/or determine a corresponding ad realization probability score of the online ad display opportunity.

In Operation 812, the server 200 may return the ad realization probability score for other commercial uses.

For example, the server 200 may return the ad realization probability score to a computer of the publisher and/or the advertiser. The advertiser may use the ad realization probability score as a reference in determining bidding of the online advertising opportunity and/or determining which ad to bid on; the publisher may use the ad realization probability score as a reference in determining a gain of placing the ad and/or evaluating profitability of a webpage or a domain.

After returning the ad realization probability score, Operation 802 may also include sending the ad to a user when the biding price wins the target ad display opportunity to fully realize the ad display opportunity. The ad may be sent by a computer of the advertiser, or may be sent by a computer of the publisher.

The ad realization probability score may reflect a probability that a user may realize (e.g., click) the ad if the ad is sent to the user who is viewing a particular website at a particular moment. If the ad realization probability score is provided to a publisher and/or an advertiser or an agent thereof on an online advertising platform such as an ad exchange, the ad realization probability score may serve as an important reference for a publisher and/or advertiser regarding how valuable winning an ad display opportunity would be. Accordingly, the ad realization probability score may affect the price that an advertiser bids and/or a strategy that the advertiser may take in an ad campaign. The ad realization probability may also affect profits that a publisher may gain from its service. For example, with the ad realization probability score, the publisher may be able to estimate a gain for placing an ad on a website, or may be able to evaluate profitability of a website, thereby may be able to design packages of services to customers.

Additionally, the ad realization probability score may also be sent to other clients, such as an online data warehouse or an online retailer. The ad realization score includes important information as to how a user (web viewer) may react to a piece of information rendered to the user. Such information may be able to predict viability of many other forms of commercial activities. For example, an online retailer, such as AMAZON™, may wish to know a probability of a resulting purchase when it sends a recommended product to a user visiting its website. A third party online warehouse may need the realization probability score to help an advertiser track down an effectiveness of an ad to offline transactions.

While example embodiments of the present disclosure relate to systems and methods for online advertisement realization probability prediction, the systems and methods may also be applied to other Applications. For example, in addition to predicting users' response to an online advertisement, the methods and systems may also be applied to other types of user response behaviors, such as predicting probability that a user may click and read a news headline on a news website or respond to a product suggestion in an online retail website, thereby improving the user experiences on the website. The present disclosure intends to cover the broadest scope of systems and methods for content browsing, generation, and interaction.

Thus, example embodiments illustrated in FIGS. 1-8 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A computer system, comprising:
a storage medium comprising a set of instructions for online ad realization prediction; and
a processor in communication with the storage medium, wherein when executing the set of instructions, the processor is directed to:
receive a plurality of target realization factors associated with a target ad display opportunity;
determine a reference realization probability score of the target ad display opportunity based on a global reference realization probability distribution associated with an ad display realization probability decision tree, wherein
the ad display realization probability decision tree comprises a plurality of leaf nodes, each leaf node comprising a plurality of historical ad display instances, and
the target ad display opportunity is associated with a target leaf node in the plurality of leaf nodes;
using the reference realization probability score, determine an ad realization probability score of the target ad display opportunity according to a piecewise calibrated realization probability function, wherein
the piecewise calibrated realization probability function comprises a plurality of pieces, each piece is a regression function obtained from:
the global reference realization probability distribution as an independent variable, and
an actual realization probability distribution associated with a plurality of historical ad display instances in a leaf node as an induced variable; and
return the ad realization probability score.

2. The system of claim 1, wherein the processor is further directed to
determine profitability of the target ad display opportunity based on the realization probability score;
determine a recommended biding price based on the realization probability score;
determine an ad to display based on the realization probability score; and
sending the ad to a user when the biding price wins the target ad display opportunity,
wherein each historical ad display instance is associated with at least one realization factor,
the at least one realization factor comprises at least one feature associated with a publisher, an advertiser, or a user of the historical ad display instance, and
the plurality of target realization factors comprises at least one feature associated with a publisher, an advertiser, or a user of the historical ad display instance.

3. The system of claim 1, wherein the ad display realization probability decision tree is constructed by repeatedly splitting a data set of historical ad display instances into the plurality of leaf nodes, wherein
each historical ad display instance is associated with at least one realization factor,
each splitting is based on a splitting criterion, which comprises a combination of two or more reference realization factors from the at least one realization factor, and
each split divides a parent node in the ad display realization probability decision tree into:
a first child node including the historical ad display instances that satisfies the splitting criterion, and
a second child node including the historical ad display instances that do not satisfy the splitting criterion.

4. The system of claim 3, wherein
the first child node is associated with a first realization probability distribution determined based on the historical ad display instances therein;
the second child node is associated with a second realization probability distribution determined based on the historical ad display instances therein;
a variation of any one of the first realization probability distribution and the second realization probability distribution over a predetermined period of time is less than a predetermined variation value, and
an overlap between the first realization probability distribution and the second realization probability distribution is less than a predetermined degree.

5. The system of claim 1, wherein the global reference realization probability distribution is associated with a weighted average realization probability distribution over the data set of historical ad display instances in the ad display realization probability decision tree.

6. The system of claim 1, wherein the global reference realization probability distribution is determined by:
obtaining an average realization probability distribution over the dataset of historical ad display instances in the ad display realization probability decision tree;
determining a reference realization probability score for each of the plurality of historical ad display instances in the leaf node based on the average realization probability distribution;
ranking the plurality of historical ad display instances in the leaf node according to their corresponding reference realization probability scores;
dividing the plurality of historical ad display instances in the leaf node into a plurality of groups according to the rank, each group including a predetermined number of ad display instances; and
for each group of the plurality of groups in the leaf node, determining an average reference realization probability score based on the reference realization probability scores of the group,
treating the average reference realization probability scores as the global reference realization probability distribution associated with the plurality of historical ad display instances in the group.

7. The system of claim 1, wherein the actual realization probability associated with the plurality of historical ad display instances in the leaf node is determined by:
obtaining an average realization probability distribution over the dataset of historical ad display instances in the ad display realization probability decision tree;
determining a reference realization probability score for each of the plurality of historical ad display instances in the leaf node based on the average realization probability distribution;
ranking the plurality of historical ad display instances in the leaf node according to their corresponding reference realization probability scores;
dividing the plurality of historical ad display instances in the leaf node into a plurality of groups according to the rank, each group including a predetermined number of ad display instances; and
determining an individual realization probability for each of the plurality of historical ad display instances in the leaf node;
for each group of the plurality of groups:
determining an average realization probability based on the individual realization probabilities of the historical ad display instances in the group;
treating the average realization probability as the actual realization probability associated with the plurality of historical ad display instances in the group.

8. A method for ad realization prediction, comprising:
receiving, by a computer, a plurality of target realization factors associated with a target ad display opportunity;
determining, by a computer, a reference realization probability score of the target ad display opportunity based on a global reference realization probability distribution associated with the ad display realization probability decision tree, wherein
the ad display realization probability decision tree comprises a plurality of leaf nodes, each leaf node comprising a plurality of historical ad display instances, and
the target ad display opportunity is associated with a target leaf node in the plurality of leaf nodes;
using the reference realization probability score, determining, by a computer, an ad realization probability score of the target ad display opportunity according to a piecewise calibrated realization probability function, wherein
the piecewise calibrated realization probability function comprises a plurality of pieces, each piece is a regression function obtained from:
the global reference realization probability distribution as an independent variable, and
an actual realization probability distribution associated with a plurality of historical ad display instances in a leaf node as an induced variable; and
returning, by a computer, the ad realization probability score.

9. The method of claim 8, further comprising:
determining, by a computer, profitability of the target ad display opportunity based on the realization probability score;
determining, by a computer, a recommended biding price based on the realization probability score;
determining, by a computer, an ad to display based on the realization probability score; and
sending the ad to a user when the biding price wins the target ad display opportunity,
wherein each historical ad display instance is associated with at least one realization factor,
the at least one realization factor comprises at least one feature associated with a publisher, an advertiser, or a user of the historical ad display instance, and
the plurality of target realization factors comprises at least one feature associated with a publisher, an advertiser, or a user of the historical ad display instance.

10. The system of claim 8, wherein the ad display realization probability decision tree is constructed by repeatedly splitting a data set of historical ad display instances into the plurality of leaf nodes, wherein
each historical ad display instance is associated with at least one realization factor,
each splitting is based on a splitting criterion, which comprises a combination of two or more reference realization factors from the at least one realization factor, and
each split divides a parent node in the ad display realization probability decision tree into:
a first child node including the historical ad display instances that satisfies the splitting criterion, and
a second child node including the historical ad display instances that do not satisfy the splitting criterion.

11. The method of claim 10, wherein
the first child node is associated with a first realization probability distribution determined based on the historical ad display instances therein;
the second child node is associated with a second realization probability distribution determined based on the historical ad display instances therein;
a variation of any one of the first realization probability distribution and the second realization probability distribution over a predetermined period of time is less than a predetermined variation value, and
an overlap between the first realization probability distribution and the second realization probability distribution is less than a predetermined degree.

12. The method of claim 8, wherein the global reference realization probability distribution is associated with a weighted average realization probability distribution over the data set of historical ad display instances in the ad display realization probability decision tree.

13. The method of claim 8, wherein the global reference realization probability distribution is determined by:
obtaining an average realization probability distribution over the dataset of historical ad display instances in the ad display realization probability decision tree;
determining a reference realization probability score for each of the plurality of historical ad display instances in the leaf node based on the average realization probability distribution;
ranking the plurality of historical ad display instances in the leaf node according to their corresponding reference realization probability scores;
dividing the plurality of historical ad display instances in the leaf node into a plurality of groups according to the rank, each group including a predetermined number of ad display instances; and
for each group of the plurality of groups in the leaf node, determining an average reference realization probability score based on the reference realization probability scores of the group,
treating the average reference realization probability scores as the global reference realization probability distribution associated with the plurality of historical ad display instances in the group.

14. The method of claim 8, wherein the actual realization probability associated with the plurality of historical ad display instances in the leaf node is determined by:
obtaining an average realization probability distribution over the dataset of historical ad display instances in the ad display realization probability decision tree;
determining a reference realization probability score for each of the plurality of historical ad display instances in the leaf node based on the average realization probability distribution;
ranking the plurality of historical ad display instances in the leaf node according to their corresponding reference realization probability scores;
dividing the plurality of historical ad display instances in the leaf node into a plurality of groups according to the rank, each group including a predetermined number of ad display instances; and
determining an individual realization probability for each of the plurality of historical ad display instances in the leaf node;
for each group of the plurality of groups:
determining an average realization probability based on the individual realization probabilities of the historical ad display instances in the group;
treating the average realization probability as the actual realization probability associated with the plurality of historical ad display instances in the group.

15. A non-transitory processor-readable storage medium, comprising a set of instructions for realization prediction, wherein when executed by a processor, the set of instructions directs the processor to perform actions of:
receiving a plurality of target realization factors associated with a target ad display opportunity;
determining a reference realization probability score of the target ad display opportunity based on a global reference realization probability distribution associated with an ad display realization probability decision tree, wherein
the ad display realization probability decision tree comprises a plurality of leaf nodes, each leaf node comprising a plurality of historical ad display instances, and
the target ad display opportunity is associated with a target leaf node in the plurality of leaf nodes;
using the reference realization probability score, determining an ad realization probability score of the target ad display opportunity according to a piecewise calibrated realization probability function, wherein
the piecewise calibrated realization probability function comprises a plurality of pieces, each piece is a regression function obtained from:
the global reference realization probability distribution as an independent variable, and
an actual realization probability distribution associated with a plurality of historical ad display instances in a leaf node as an induced variable; and
returning the ad realization probability score.

16. The storage medium of claim 15, wherein the set of instructions further direct the processor to perform acts of:
determining profitability of the target ad display opportunity based on the realization probability score;
determining a recommended biding price based on the realization probability score;
determining an ad to display based on the realization probability score; and
sending the ad to a user when the biding price wins the target ad display opportunity,
wherein each historical ad display instance is associated with at least one realization factor,
the at least one realization factor comprises at least one feature associated with a publisher, an advertiser, or a user of the historical ad display instance, and
the plurality of target realization factors comprises at least one feature associated with a publisher, an advertiser, or a user of the historical ad display instance.

17. The storage medium of claim 15, wherein the ad display realization probability decision tree is constructed by repeatedly splitting a data set of historical ad display instances into the plurality of leaf nodes, wherein
each historical ad display instance is associated with at least one realization factor,
each splitting is based on a splitting criterion, which comprises a combination of two or more reference realization factors from the at least one realization factor, and
each split divides a parent node in the ad display realization probability decision tree into:
a first child node including the historical ad display instances that satisfies the splitting criterion, and
a second child node including the historical ad display instances that do not satisfy the splitting criterion.

18. The storage medium of claim 17, wherein
the first child node is associated with a first realization probability distribution determined based on the historical ad display instances therein;
the second child node is associated with a second realization probability distribution determined based on the historical ad display instances therein;
a variation of any one of the first realization probability distribution and the second realization probability distribution over a predetermined period of time is less than a predetermined variation value, and
an overlap between the first realization probability distribution and the second realization probability distribution is less than a predetermined degree.

19. The storage medium of claim 15, wherein the global reference realization probability distribution is associated with a weighted average realization probability distribution over the data set of historical ad display instances in the ad display realization probability decision tree.

20. The storage medium of claim 15, wherein the global reference realization probability distribution is determined by:
obtaining an average realization probability distribution over the dataset of historical ad display instances in the ad display realization probability decision tree;
determining a reference realization probability score for each of the plurality of historical ad display instances in the leaf node based on the average realization probability distribution;
ranking the plurality of historical ad display instances in the leaf node according to their corresponding reference realization probability scores;
dividing the plurality of historical ad display instances in the leaf node into a plurality of groups according to the rank, each group including a predetermined number of ad display instances; and
for each group of the plurality of groups in the leaf node, determining an average reference realization probability score based on the reference realization probability scores of the group,
treating the average reference realization probability scores as the global reference realization probability distribution associated with the plurality of historical ad display instances in the group.
wherein the actual realization probability associated with the plurality of historical ad display instances in the leaf node is determined by:
determining an individual realization probability for each of the plurality of historical ad display instances in the leaf node;
for each group of the plurality of groups, determining an average realization probability based on the individual realization probabilities of the historical ad display instances in the group; and
treating the average realization probability as the actual realization probability associated with the plurality of historical ad display instances in the group.
